(19) United States
(12) Patent Application Publication
(10) Pub. No.: US 2015/0097690 A1
(43) Pub. Date: Apr. 9, 2015

(54) Method and Apparatus of Electronic Device for Abuse Detection and Notification

(71) Applicant: MOTOROLA MOBILITY LLC, Libertyville, IL (US)

(72) Inventors: Roger W. Ady, Chicago, IL (US); Jiri Slaby, Buffalo Grove, IL (US); Jason P. Wojack, Libertyville, IL (US); Hong Zhao, Naperville, IL (US)

(73) Assignee: MOTOROLA MOBILITY LLC, Libertyville, IL (US)

(21) Appl. No.: 14/048,178

(22) Filed: Oct. 8, 2013

(51) Int. Cl. G01M 99/00; G08B 21/18

(52) U.S. Cl. CPC G01M 99/005; G08B 21/182
USPC 340/665

(57) ABSTRACT

A method of an electronic device for abuse detection and notification is disclosed herewith. The method includes monitoring one or more parameters at the electronic device for one or more physical events, the parameter(s) being associated with one or more imagers. The method further includes identifying the physical event(s) at the electronic device by determining that each parameter exceeds a corresponding threshold value. Next, the method provides storing event data corresponding to the physical event(s), in which at least a portion of the event data is associated with the parameter(s). The method further includes generating a notification associated with the physical event(s).

### FIELD OF THE DISCLOSURE

The present disclosure relates generally to a communication device and more particularly to a method and apparatus for abuse detection and notification at the communication device.

### BACKGROUND

In the present systems, portable products, such as mobile devices, by their nature are frequently mishandled beyond their specifications, resulting in damage or failure of the device. Because of absent obvious evidence of the cause of the damage, the responsibility for subsequent repair or replacement is often difficult to ascertain between manufacturer, retailer, and customer. In addition, it is difficult for the manufacturer or retailer to question a suspicious request for remedy given the customers' ability to launch an internet-driven attack in retaliation for a verdict of customer abuse.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a wireless communication system in accordance with some embodiments of the present invention.

FIG. 2 is a block diagram of an electronic device or a server in accordance with some embodiments of the present invention.

FIGS. 3A and 3B are arrangements of notification and/or event data in accordance with some embodiments of the present invention.

FIG. 4 is a flowchart of a method in accordance with some embodiments of the present invention.

FIG. 5 is a flowchart of a method in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail the particular method of an electronic device for abuse detection and notification, in accordance with an embodiment of the present disclosure, it should be observed that the present disclosure resides primarily in combinations of method steps and apparatus components related to the method of an electronic device for abuse detection and notification. Accordingly, the apparatus components and method steps have been represented where appropriate by conventional symbols in the drawings, showing only those specific details that are pertinent to understanding the present disclosure, so as not to obscure the disclosure with details that will be readily apparent to those of ordinary skill in the art, having the benefit of the description herein.

A method of an electronic device for abuse detection and notification is disclosed herewith. The method includes monitoring one or more parameters at the electronic device for at least one physical event, at least one parameter of the one or more parameters being associated with one or more imagers. The method further includes identifying the physical event or events at the electronic device by determining that each parameter of the one or more parameters exceeds a corresponding threshold value. Further, the method provides storing event data corresponding to the physical event or events on the electronic device or a server, in which at least a portion of the event data is associated with the parameter or parameters of the one or more parameters. The method further includes generating a notification associated with the physical event or events.

An electronic device for abuse detection and notification is disclosed herewith. The electronic device comprises one or more sensors configured to monitor one or more parameters at the electronic device for at least one physical event, at least one parameter of the one or more parameter being associated with one or more imagers. The electronic device further includes a processor configured to identify the physical event or events at the electronic device by determining that each parameter of the one or more parameters exceeds a corresponding threshold value. Further, the electronic device comprises a memory configured to store event data corresponding to the physical event or events on the electronic device or the server, in which at least a portion of the event data is associated with the parameter or parameters of the one or more parameters. The electronic device further includes a notification generator configured to generate a notification associated with the physical event or events.

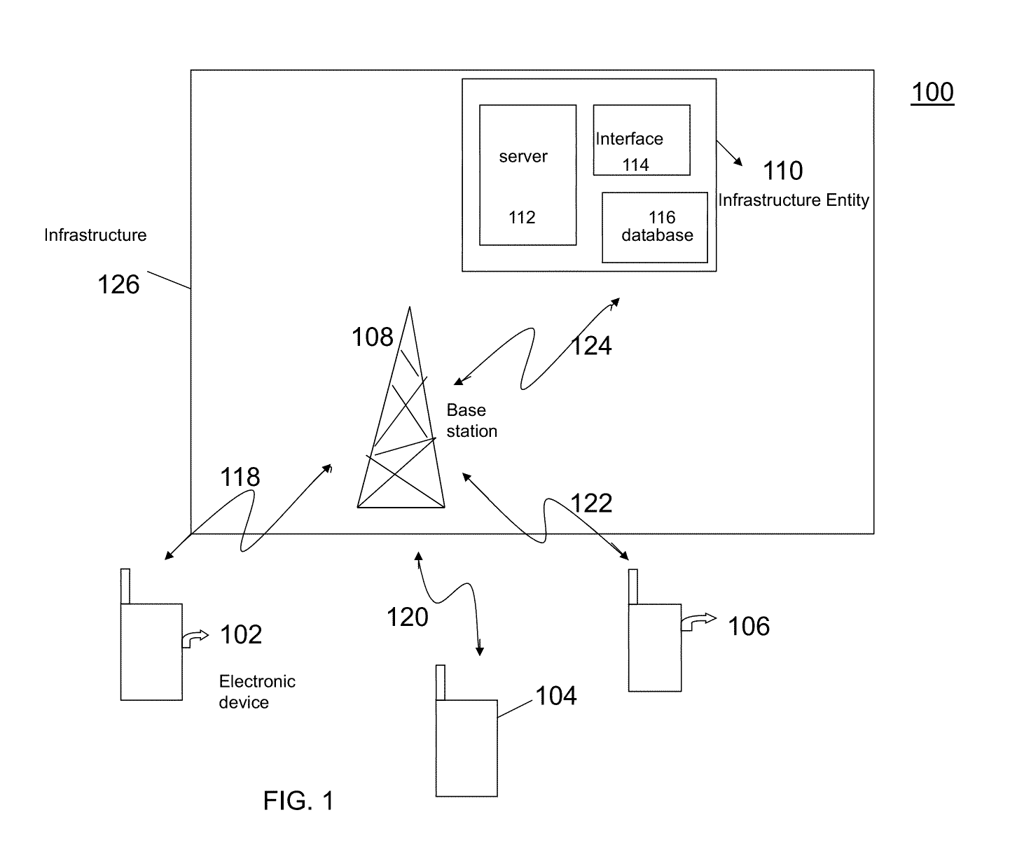

FIG. 1 illustrates a schematic of a wireless communication system 100 in accordance with some embodiments. The wireless communication system 100 includes one or more electronic devices 102, 104, 106 communicating with one or more base stations 108 via wireless links or wired links 118, 120, 122. Further, the wireless communication system includes an infrastructure entity 110 communicating with the base station 108 via wireless or wired link 124 (for example, landline connections such as fiber optic or copper wiring connections, microwave communications, radio channel communications, and/or wireless path communications) depending upon the embodiment or device that is involved. The infrastructure entity 108 further includes a server 112, an interface 114, and a database 116.

In accordance with the embodiment, the base station 108 in the wireless communication system 100 is configured to operate according to any of a number of different communication technologies including, but not limited to, 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies.

Still referring to FIG. 1, an electronic device 102-106 is intended to be representative of any of a variety of devices operated by persons (or users) or possibly by other entities (e.g., other computers). In some embodiments, for example, the electronic device 102-106 can be, but not limited to, any of a call receiver, cellular telephone, a personal digital assistant (PDAs), a smart phone, another handheld or portable electronic device, a headset, a MP3 player, a battery-powered device, a wearable device, a radio, a navigation device, a laptop or notebook computer, a notebook, a pager, a PMP (personal media player), a DVR (digital video recorder), a gaming device, a camera, a notebook, an e-reader, an e-book, a tablet device, a navigation device with a video capable screen, a multimedia docking station, or another mobile. The electronic device 102-106 may be served by the base station 108.

The infrastructure entity 110 is a network element that is connected to the various other elements in the wireless communication system 100. For example, the infrastructure entity 110 is connected to the electronic devices 102-106 through the base station 108 serving the electronic devices 102-106. The infrastructure entity 110 routes the communications to electronic devices 102-106 via base station 108 or via a PSTN/Internet/other network elements. The infrastructure entity 110 includes the server 112, the transceiver 114, and the database 116. The server 112 is a central system of the infrastructure entity 110 which controls the other elements of the infrastructure entity 110 and provides services to the electronic devices 102-106 connected to the infrastructure entity 110. The server 112 is also intended to be representative of any computerized device or terminal (or several of these) with which the electronic devices 102-106 and the base station 108 is capable of communicating, for the purpose of receiving or transmitting information.

The interface 114 is intended to be representative of a communicating interface. The interface 114 enables entities like base station 108 to communicate with the infrastructure entity 110. The interface 114 may be a part of the server 112 and not necessarily a separate element in the infrastructure entity 110. The database 116 stores the information and data related to the electronic devices 102-106 connected to the infrastructure entity 110 and various other data required by the server 112.

Further, it is to be understood that FIG. 1 is provided merely for the purpose of illustrating the principles of the present invention. FIG. 1 is not intended to be a comprehensive schematic diagram of all of the components of such a communication system. Therefore, wireless communication system 100 may comprise various other configurations and still be within the scope of the present disclosure.

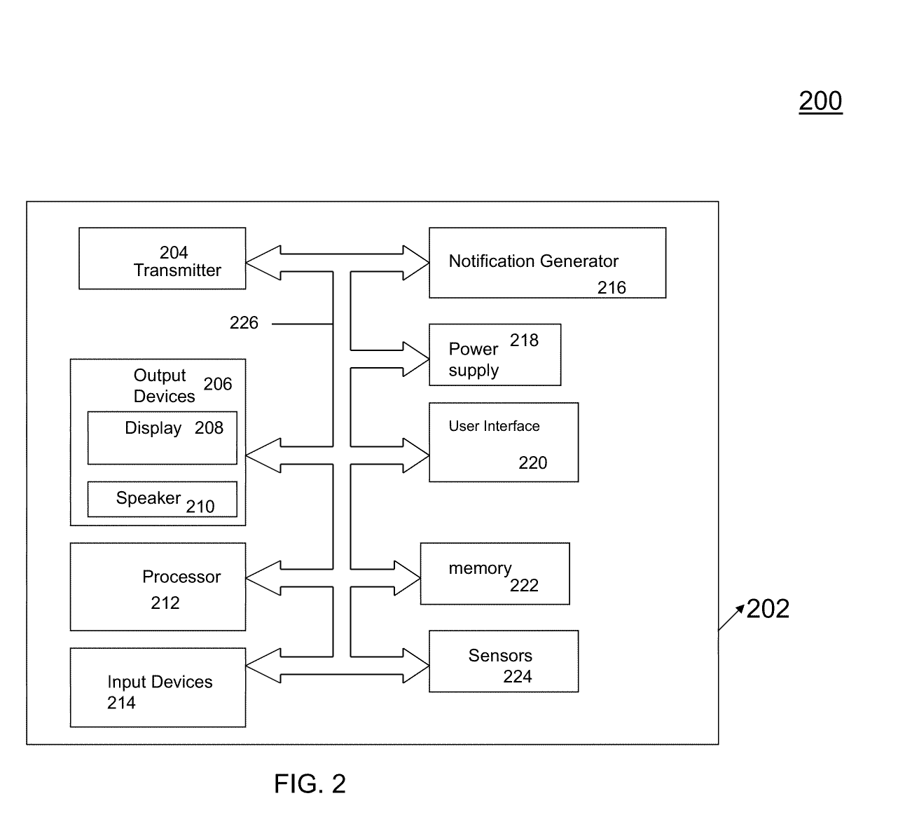

Referring to FIG. 2, there is provided a block diagram 200 illustrating example internal hardware components of the electronic device 102-106 and/or the server 112 of the infrastructure entity 110 of FIG. 1. For the purposes of the explanation below, the block diagram 200 will be referred to as describing internal hardware components of a communication device 202. Herein, the communication device 202 refers to electronic device 102-106 and/or the server 112.

The block diagram 200 of the communication device 202 includes various components. Example components include a transmitter 204, an output device 206 including a display 208 and a speaker 210, a processor 212, input devices 214, a notification generator 216, a power supply 218, a interface 220, a memory 222, and sensors 224, each capable of communicating with one or more components of the communication device 202. For example, as shown in FIG. 2, all components are coupled to a bidirectional system bus 226 having one or more of a data communication path, a control communication path or a power supply path.

In accordance with an embodiment, the transmitter 204 can be implemented as a transmitter or a transceiver component of the communication device 202. The transmitter 204 enables the communication device 202 to transmit RF signals through an antenna (not shown). In accordance with the embodiment, the transmitter 204, implemented as a transceiver, can transmit RF signals through the antenna and can convert the RF signals received from the antenna to digital data for use by the processor 212.

The output device 206 may generate visual indications of data generated during operation of the processor 212. The visual indications may include prompts for human operator input, calculated values, detected data, etc. Additionally, the output device 206 may include a video output component such as a display device 208 which includes cathode ray tube, liquid crystal display, plasma display, incandescent light, fluorescent light, front or rear projection display, and light emitting diode indicator. Other examples of output components 206 include an audio output component such as a speaker 210, alarm and/or buzzer, and/or a mechanical output component such as vibrating or motion-based.

In accordance with an embodiment, the input devices 214 may be connected to the processor 212 for providing input by a user. Input devices 214 may include one or more components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and may include a pointing device such as a joystick and buttons used on laptop or notebook computers, a track ball, a touch pad, a rocker switch, a touch screen, a TTY input device for disable persons, a Braille key input, or a pad for handwriting pen, optical track pad, eye/face tracking input, for example. The input devices 214 enable a user of the communication device 202 to provide an input for the communication device 202.

In accordance with an embodiment, the notification generator 216 may be connected to the processor 212 for generating notifications associated with various events at the communication device 202. The generated notification may be a visual notification or an audio notification or vibratory (haptic) notification. The visual notification may include one or more of a pop-up message notification, an email notification, a text message, a multimedia message, or a social network notification. The visual notification may also include a graphical representation of the impact, a location map, a location image, a surface image, or a video recording. The audio notification may include one or more of a voicemail message or an audio message.

Further, the power supply 218, such as a battery, may be included in the internal components of the communication device 202 for providing power to the other internal components while enabling the communication device 202 to be portable.

In accordance with an embodiment, the user interface 220 may be connected to the processor 212 for entering data and commands in the form of text, touch input, gestures, etc. The user interface 220 is, in one embodiment, a touch screen device but may alternatively be an infrared proximity detector or any input/output device combination capable of sensing gestures and/or touch including a touch-sensitive surface. In addition, the user interface 220 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and may include a pointing device such as a joystick and buttons used on laptop or notebook computers, a track ball, a touch pad, a rocker switch, a touch screen, a TTY input device for disable persons, a Braille key input, or a pad for handwriting pen, optical track pad, eye/face tracking input, for example. The user interface 220 enables a user of the communication device 202 to provide an input for the communication device 202.

Still referring to FIG. 2, the memory 222 may be used to store data and instructions for the operation of the processor 212. The memory 222 may be a volatile memory or a non-volatile memory. In the various embodiments, the memory 222 may be one or more separate components and/or may be partitioned in various ways for various purposes such as but not limited to, optimizing memory allocations, etc. Thus it is to be understood that the example memory 222 illustrated in FIG.2 are for illustrative purposes only, for the purpose of explaining and assisting one of ordinary skill in understanding the various embodiments described herein.

Further, the processor 212 operates in conjunction with the data and instructions stored in the memory 222 to control the operation of the communication device 202. The processor 212 may be implemented as a microcontroller, a digital signal processor, hard-wired logic and analog circuitry, or any suitable combination of these.

Further, the sensors 224 may be connected to the processor 212 for monitoring one or more parameters at the communication device 202. The one or more sensors include at least one of a gyroscope, a microphone, a barometer, an accelerometer, a proximity sensor, a global positioning system (GPS), an indoor navigation sensing, or an imager.

It is to be understood that FIG. 2 is for illustrative purposes only and is primarily for, although not solely for, explaining the information stored in memory for the various embodiments of a communication device in accordance with the present disclosure, and is not intended to be a complete schematic diagram of the various components and connections there between required for an electronic device. Therefore, a communication device 202 will comprise various other components not shown in FIG. 2, and/or have various other configurations internal and external, and still be within the scope of the present disclosure. Also, one or more of these components may be combined or integrated in a common component, or components features may be distributed among multiple components. Also, the components of the communication device 202 may be connected differently, without departing from the scope of the invention.

Finally, as mentioned above, FIG. 2 can also be considered to be equally or substantially equally representative of the internal components of electronic device 102-106 and/or server 112.

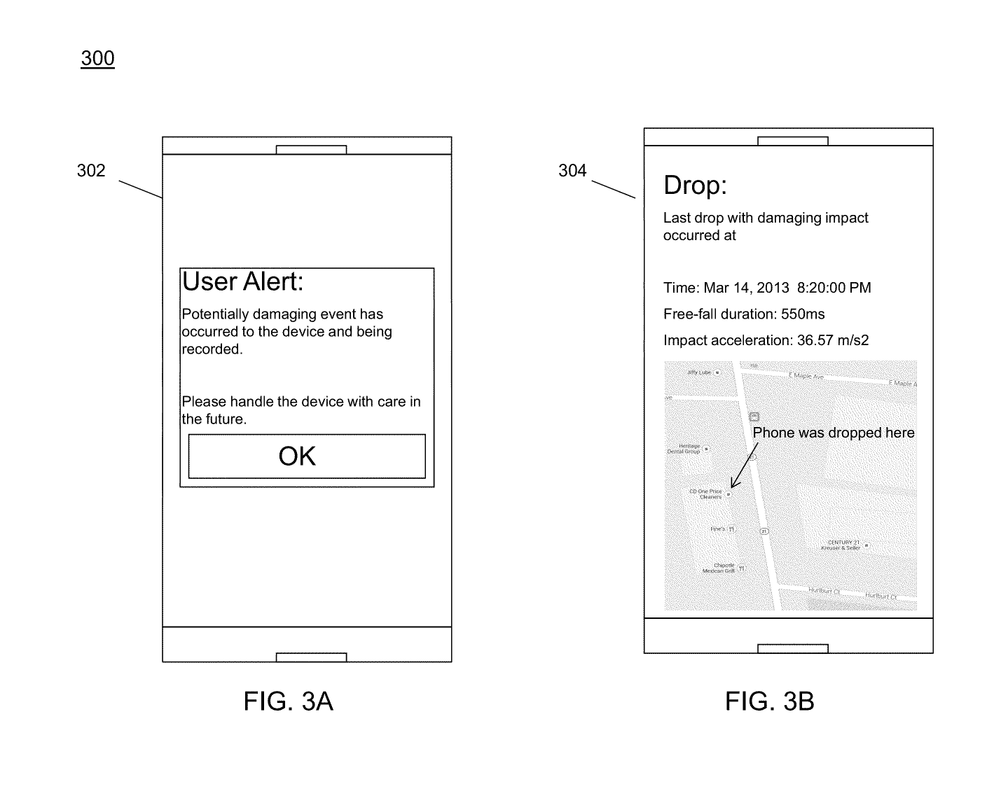

Referring to FIG. 3A, an arrangement 302 is an illustrating example arrangement of a visual notification generated by the electronic device 102-106. The visual notification generated by the electronic device 102-106 may be a pop-up message notification, an email notification, a text message, a multimedia message, a social network notification, a notification displayed at a status bar, a notification displayed in a notification window, a notification displayed as an icon on a locked screen of the electronic device 102-106, a notification displayed on the home screen of the electronic device 102-106, a notification or message on another device such as a laptop, desktop computer, tablet, other phone, and similar via email, (automated) voicemail, message, social networks, etc. The use of multiple notification schemes on multiple electronic devices or systems is important for a case where the abused device looses functionality as a result of the abuse, such as suffering a cracked display. The generated visual notification may require an acknowledgement from a user of the electronic device 102-106. For example, in the arrangement 302, the notification indicates a user alert referring to potentially damaging event or a physical event that has occurred at the electronic device 102-106 and being recorded. Herein, the recorded physical event may be replayable as a video, audio, or impact diagram. This notification may require an acknowledgement from a user of the electronic device 102-106. In an embodiment, the notification may be recorded at the electronic device 102-106. Alternatively, the notification may be recorded at the electronic device 102-106 and may be transmitted to a server 112. The generated and/or recorded notification may serve the purpose of deflecting a user of the electronic device 102-106 from making false or misleading warranty claims to the manufacturer or the retailer, and also offering the user with pricing and instructions on how to have electronic device 102-106 checked, repaired, or replaced with a refurbished electronic device 102-106. The notification also may remind the user to backup the electronic device 102-106 or provide a short-cut to do this. In addition, the notification may include a link to a suitable companion product offering to mitigate the damage likely from the detected abuse, such as a waterproof case or a shock-absorbing case. Besides reducing warranty claims, the above scenarios may generate additional sales through backup services or case sales.

Referring to FIG. 3B, an arrangement 304 is illustrating an example arrangement of event data associated with a physical event data stored on the electronic device 102-106. The event data may be stored on a memory 222 of the electronic device 102-106 and may be displayed on the display 208 of the electronic device 102-106. Herein, the memory 222 may be a non-volatile memory. The event data may include one or more of time of the occurrence of the physical event, free-fall duration, drop duration, physical impact value or strength, drop height, shock value, drop surface type, or drop location including a map and a surface description, a video, an audio, and images. Particularly, the arrangement 304 indicates physical event data that corresponds to a drop. The physical event data may be about last drop occurred at the electronic device 102-106. The physical event data may include time at which the drop occurred, free fall duration of the drop, and strength of the impact at the electronic device 102-106. The event data may also be stored in the form of a graph. In an example, the graph may be an acceleration vs. time graph for the last drop occurred at the electronic device 102-106.

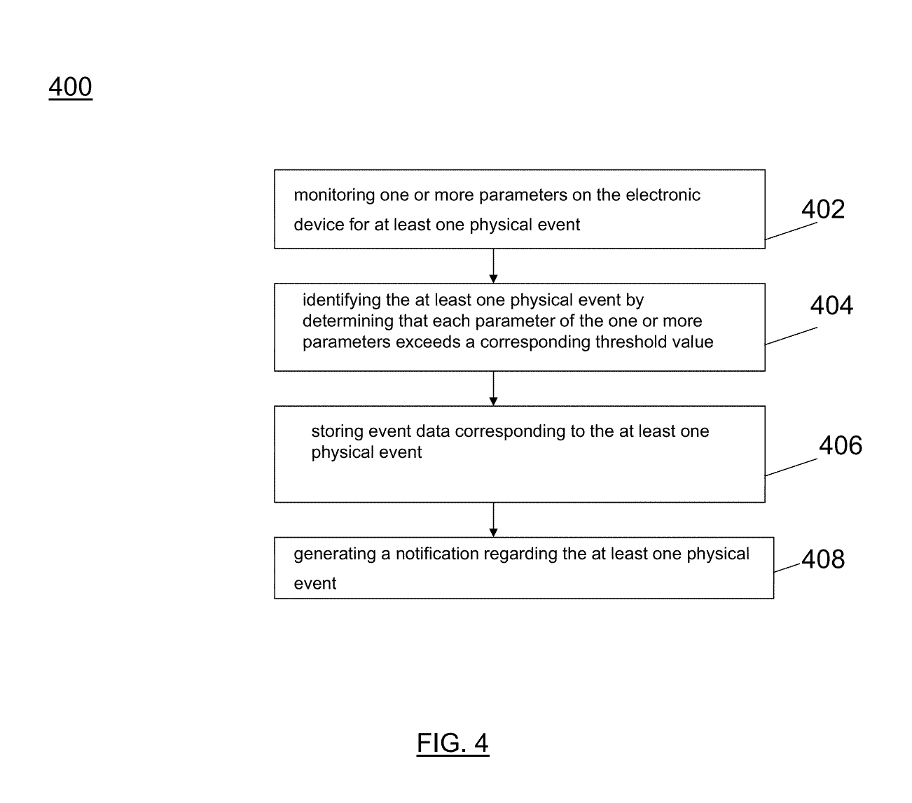

FIG. 4 is a flowchart for a method 400 for abuse detection and notification of an electronic device 102-106. The method 400 begins with monitoring, by one or more sensors, one or more parameters on the electronic device for at least one physical event. Herein, at least one parameter of the one or more parameters is associated with one or more imagers. Particularly, the one or more parameters may comprise at least one of a freefall state, a drop duration of the electronic device 102-106, a physical impact value, a drop height, a shock value, a drop surface type, or a drop location.

The one or more parameters may correspond to one or more sensors at the electronic device. The one or more sensors may comprise at least one of a gyroscope sensor, a microphone, a barometer, an accelerometer, a proximity sensor, a GPS, an indoor navigation sensing, or an imager. For example, barometer may assist in drop height determination and gyroscope may assist in determining rotational information. Similarly, microphone and/or imagers may assist in determining drop surface i.e., the surface on which the electronic device 102-106 fell. Particularly, the microphone may also provide acoustic assistance. Likewise, imagers may assist in drop location at which the electronic device fell or dropped. Imagers may also assist in determining corner, side, or edge of the electronic device 102-106 by which the electronic device 102-106 fell or drop. Particularly, imagers may assist in determining orientation of the drop, surface, and surroundings.

The method 400 moves to step 404 of identifying, by a processor 212, at least one physical event at the electronic device 102-106 by determining that each parameter of the one or more parameters exceeds a corresponding threshold value. For example, for parameters like free fall state and drop duration of the electronic device 102-106, a threshold value may include a particular free fall duration value. Herein, the free fall duration value is likely to be measured in seconds or a fraction of a second, and may be measured in minutes. The processor 212 may only identify a physical event that exceeds the particular free fall duration value. For a parameter like physical impact value, the threshold value may include a particular physical impact acceleration value. The physical impact acceleration value may be in unit m/ŝ2 or any other known unit of measuring physical impact. The processor 212 may only identify a physical event that exceeds the particular physical impact acceleration value. For a parameter like drop surface type, a threshold value may include various surface types. For example, a processor 212 may identify a physical event when a surface is a hard surface such as marble flooring. However, if the surface is not so hard, like a bed mattress, the processor 212 may not identify the physical event. In an example, one or more imagers may be activated before identifying the at least one physical event at the electronic device 102-106. Drop height may be determined and reported using a barometer as it will allow to detect both direct drop, such as from a table, and an upward thrown drop, such as when the device is thrown or ejected upward or sideways and follows certain trajectory.

The method 400 then moves to step 406 of storing, at the memory 222, event data corresponding to the at least one physical event. Herein, at least a portion of the event data is associated with the at least one parameter of the one or more parameters. In an example, data corresponding to the at least one physical event may be stored at a non-volatile memory of the electronic device 102-106. In yet another example, the data corresponding to the at least one physical event may be transmitted, by a transmitter 204, to a server 112 and may be stored at the server 112 of the infrastructure entity 110.

The method 400 then moves to step 408 of generating at the electronic device 102-106, by a notification generator 216, a notification associated with the at least one physical event. The generated and/or recorded notification may serve the purpose of deflecting a user of the electronic device 102-106 from making false or misleading warranty claims, and also offering the user with pricing and instructions on how to have electronic device 102-106 checked, repaired, or replaced with a refurbished electronic device 102-106. The generated notification may be transmitted to a remote device or server 112 via the transmitter 204. The generated notification may be served at the remote device or server 112. The generated notification may include various types of indications for the user of the electronic device 102-106. Example indications may include messages like “Ouch, that hurt! Maybe you should get a protective case”.

The notification generator 216 may generate at least one of a visual notification or an audio notification. In an example, the notification the visual notification may include at least one of a pop-up message notification, an email notification, a text notification, a multimedia (video and/or audio) notification, a social network notification, a notification displayed at a status bar, a notification displayed in a notification window, a notification displayed as an icon on a locked screen of the electronic device 102-106, or a notification displayed on the home screen of the electronic device 102-106. The audio notification may include at least one of a voicemail message or an audio message. In example, a user's acknowledgement for the notification, at the electronic device 102-106, may be required. In yet another example, a user's acknowledgement for the notification, at the electronic device 102-106, may be even necessary for storing the event data corresponding to the at least one physical event on the electronic device 102-106 or the server. In yet another embodiment, along with the generated notification, the user of the electronic device 102-106 may be provided with pricing and instructions on how to have electronic device 102-106 checked, repaired, or replaced with a refurbished electronic device 102-106. The generated notification may be stored and/or recorded at the electronic device 102-106. The recorded/stored notification may help a manufacturer or retailer of the electronic device 102-106 to keep a check on false warranty claims.

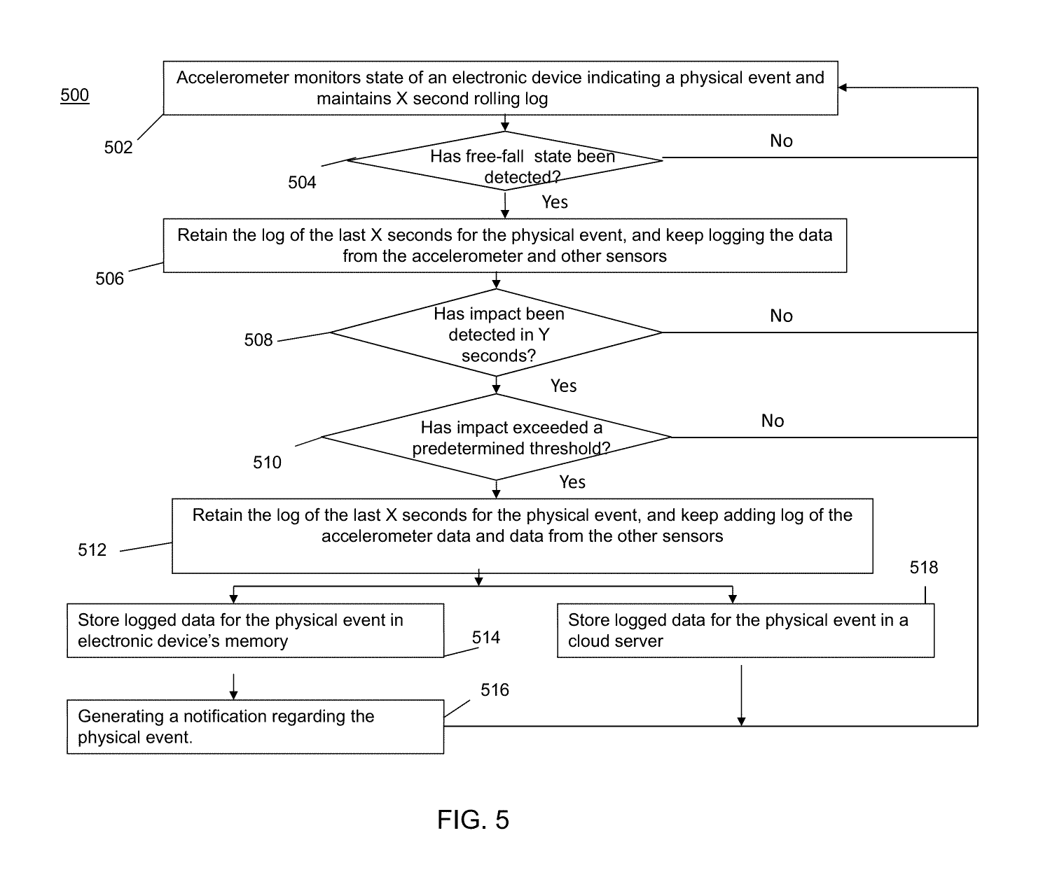

FIG. 5 is a flowchart for a method 500 for abuse detection and notification of the electronic device 102-106. Referring to FIG. 5, the method 500 begins with step 502 of an accelerometer, at the electronic device 102-106, monitoring state of the electronic device 102-106 indicating a physical event and maintaining an X seconds rolling log. Further, in step 504, the processor 212 determines if a free-fall state has been detected at the electronic device. If not, then the method 500 moves back to step 502. If yes, then the method 500 moves to step 506 of retaining the log of the last X seconds for the physical event. Herein, the accelerometer and other sensors keep logging data at the electronic device 102-106. Free-fall state is when the electronic device 102-106 is not in contact with any surface and is in downward motion where its weight is the only force acting upon it. Further, the method 500 moves to step 508 of detecting whether an impact has been detected in Y seconds on the electronic device 102-106. Herein, in an example, the impact may be a physical impact caused due to drop of the electronic device 102-106.

Then, the method 500 moves to step 510 of detecting whether the impact has exceeded a predetermined threshold. In an example, the predetermined threshold is at least one of particular shock value, a minimum shock value, or a particular physical impact value. Further, if the detected impact has not exceeded the predetermined threshold, the method 500 moves to step 502. If the detected impact has exceeded the predetermined threshold, the method 500 moves to step 512 of retaining the log of the last X seconds for the physical event and continuing adding log of the accelerometer data and data from the other sensors. Further, the method 500 moves to step 514 of storing logged data for the physical event in the memory 222 of the electronic device 102-106. Then, in step 516, a notification regarding the physical event is generated at the electronic device 102-106. In an embodiment, the method 500 moves to step 518 of storing the logged data for the physical event on a cloud server. Then, in step 516, a notification regarding the physical event is generated at the electronic device 102-106 by the cloud server.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, and/or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of an electronic device for abuse detection and notification, the method comprising:
monitoring one or more parameters at the electronic device for at least one physical event, at least one parameter of the one or more parameters being associated with one or more imagers;
identifying the at least one physical event at the electronic device by determining that each parameter of the one or more parameters exceeds a corresponding threshold value;
storing event data corresponding to the at least one physical event, wherein at least a portion of the event data is associated with the at least one parameter of the one or more parameters; and
generating a notification associated with the at least one physical event.

2. The method of claim 1, wherein the one or more parameters comprise at least one of a freefall state, a drop duration of the electronic device, a physical impact value, a drop height, a shock value, a drop surface type, or a drop location.

3. The method of claim 1, wherein the one or more parameters correspond to one or more sensors at the electronic device.

4. The method of claim 3, wherein the one or more sensors include at least one of a gyroscope sensor, a microphone, a barometer, an accelerometer, a proximity sensor, a GPS, an indoor navigation sensing, or an imager.

5. The method of claim 1 further comprising
activating the one or more imagers before identifying the at least one physical event at the electronic device.

6. The method of claim 1, wherein the event data is stored at memory of the electronic device.

7. The method of claim 1, wherein the event data is stored at a server.

8. The method of claim 1, wherein the notification is at least one of a visual notification or an audio notification.

9. The method of claim 8, wherein the visual notification includes at least one of a pop-up message notification at the electronic device, an email notification, a text message, a multimedia message, or a social network notification.

10. The method of claim 8, wherein the audio notification includes at least one of a voicemail message or an audio message.

11. An electronic device for abuse detection and notification, the electronic device comprising:
one or more sensors configured to monitor one or more parameters at the electronic device for at least one physical event, at least one parameter of the one or more parameter being associated with one or more imagers;
a processor configured to identify the at least one physical event at the electronic device by determining that each parameter of the one or more parameters exceeds a corresponding threshold value;
a memory configured to store event data corresponding to the at least one physical event, wherein at least a portion of the event data is associated with the at least one parameter of the one or more parameters; and
a notification generator configured to generate a notification associated with the at least one physical event.

12. The electronic device of claim 11, wherein the one or more parameters comprise at least one of a freefall duration of the electronic device, a physical impact value, a drop height, a shock value, a drop surface type, or a drop location.

13. The electronic device of claim 11, wherein the one or more parameters correspond to the one or more sensors at the electronic device.

14. The electronic device of claim 13, wherein the one or more sensors include at least one of a gyroscope sensor, a microphone, a barometer, an accelerometer, a proximity sensor, a GPS, an indoor navigation sensing, or an imager.

15. The electronic device of claim 11, wherein the one or more imagers are activated before the processor identifies the at least one physical event at the electronic device.

16. The electronic device of claim 11, wherein the notification generator generates at least one of a visual notification or an audio notification.

17. The electronic device of claim 16, wherein the visual notification includes at least one of a pop-up message notification, an email notification, a text notification, a multimedia notification, or a social network notification.

18. The electronic device of claim 16, wherein the audio notification includes at least one of a voicemail message or an audio message.

19. The electronic device of claim 11, wherein the at least one physical event is replayable.

20. The electronic device of claim 11, wherein the electronic device further comprises:
a transmitter configured to transmit the event data to a server.
